(19) United States
(12) Patent Application Publication
(10) Pub. No.: US 2018/0218470 A1
(43) Pub. Date: Aug. 2, 2018

(54) PERSONALIZED SEAT SYSTEM FOR RIDESHARE VEHICLE INTERIOR

(71) Applicant: FORD GLOBAL TECHNOLOGIES, LLC, Dearborn, MI (US)

(72) Inventors: Jamel E. BELWAFA, Ann Arbor, MI (US); Manoharprasad K. RAO, Novi, MI (US); Mark A. CUDDIHY, New Boston, MI (US)

(21) Appl. No.: 15/417,380

(22) Filed: Jan. 27, 2017

(51) Int. Cl. G06Q 50/30; G06Q 10/02

(52) U.S. Cl. CPC G06Q 50/30; G06Q 2240/00; G06Q 10/02

(57) ABSTRACT

A vehicle is selected by the server to perform a ride-share. A seating location within the vehicle is identified. The seating location and personalized ride-sharing settings for the user account are sent to the vehicle to cause the vehicle to precondition the seating location according to the settings, prior to the user entering the vehicle.

### TECHNICAL FIELD

Aspects of the disclosure generally relate to personalized seat settings for an interior of a rideshare vehicle.

### BACKGROUND

Individual seating-position-specific HVAC (heating, ventilation, and air-conditioning) controls are currently available in some vehicles. For example, front seating dual air-conditioning/heating controls are positioned at the instrument cluster between the driver and front passenger for adjustment of the settings to their individual preferences.

### SUMMARY

In one or more illustrative embodiments, a system includes a mobile device associated with a user of a ride-share server, programmed to receive information indicative of a vehicle selected by the server to perform a ride-share, identify a seating location within the vehicle, and send the seating location and personalized ride-sharing settings for the user account to the vehicle to cause the vehicle to precondition the seating location according to the settings, prior to the user entering the vehicle.

In one or more illustrative embodiments, a method includes receiving a ride-share request from a mobile device of a user; identifying a vehicle to perform the ride-share request by limiting available vehicles according to personalized ride-sharing settings of the user; sending the vehicle an indication of the ride-share request and a seating location for the user; and providing the vehicle with the personalized ride-sharing settings for preconditioning the seating location prior to the user entering the vehicle.

In one or more illustrative embodiments, a non-transitory computer-readable medium including instructions that, when executed by a processor of a computing system of a vehicle, cause the system to receive personalized ride-sharing settings for preconditioning a seating location of the vehicle, responsive to selection of the vehicle for performing a ride-share for a user; and apply the settings to control systems to adjust seating, entertainment, and ventilation settings of the seating location prior to the user entering the vehicle.

### BRIEF DESCRIPTION OF THE DRAWINGS

FIG. 1 illustrates an example system including a vehicle for providing personalized ride-sharing settings to individual seat control systems;

FIG. 2 illustrates an example user interface of the mobile device for selecting personalized ride-sharing settings for an upcoming rideshare;

FIG. 3 illustrates an example user interface of the mobile device for selecting a seat location for the ride-share;

FIG. 4 illustrates an example user interface of the mobile device for configuring personalized ride-sharing settings;

FIG. 5 illustrates an example process of the vehicle for a mobile device requesting a ride-share using personalized ride-sharing settings; and

FIG. 6 illustrates an example process for a ride-share server managing a requested ride-share using personalized ride-sharing settings.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

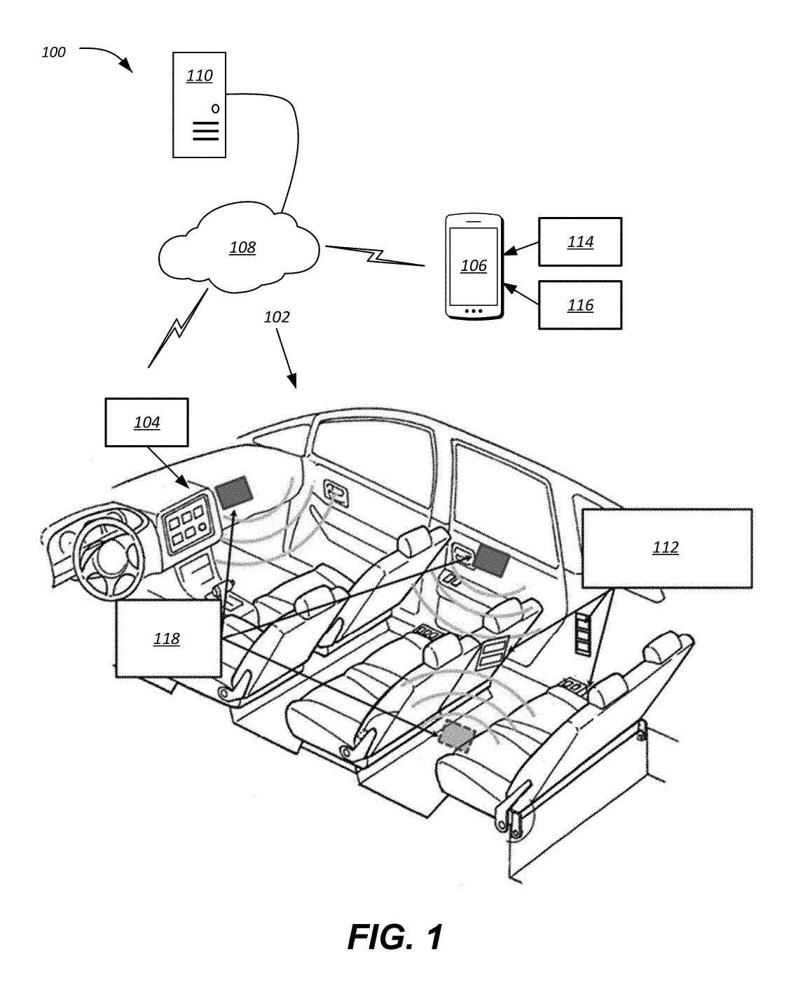

FIG. 1 illustrates an example system 100 including a vehicle 102 for providing personalized ride-sharing settings 114 to individual seat control systems 112. The vehicle 102 may include a vehicle computing system (VCS) 104 configured to communicate over a wide-area network 108, e.g., using a mobile device 106. As shown, the system 100 includes sensors 118 to detect the identity of occupants according to detection of a mobile device 106 of the occupant. The mobile device 106 may be configured to utilize a ride-sharing application 116 installed to the mobile device 106 to request use of the vehicle 102 from a ride-sharing server 110. As part of the request process, personalized ride-sharing settings 114 may be provided to the vehicle 102 to be applied to the seat control systems 112. These personalized ride-sharing settings 114 may be applied when the vehicle 102 is hailed, before the user has entered the vehicle 102. While an example system 100 is shown in FIG. 1, the example components as illustrated are not intended to be limiting. Indeed, the system 100 may have more or fewer components, and additional or alternative components and/or implementations may be used.

The vehicle 102 may include various types of automobile, crossover utility vehicle (CUV), sport utility vehicle (SUV), truck, recreational vehicle (RV), boat, plane or other mobile machine for transporting people or goods. In many cases, the vehicle 102 may be powered by an internal combustion engine. As another possibility, the vehicle 102 may be a hybrid electric vehicle (HEV) powered by both an internal combustion engine and one or more electric motors, such as a series hybrid electric vehicle (SHEV), a parallel hybrid electrical vehicle (PHEV), or a parallel/series hybrid electric vehicle (PSHEV). As the type and configuration of vehicle 102 may vary, the capabilities of the vehicle 102 may correspondingly vary. As some other possibilities, vehicles 102 may have different capabilities with respect to passenger capacity, towing ability and capacity, and storage volume.

The VCS 104 may be configured to support voice command and BLUETOOTH interfaces with the driver and driver carry-on devices, receive user input via various buttons or other controls, and provide vehicle status information to a driver or other vehicle 102 occupants. An example VCS 104 may be the SYNC system provided by FORD MOTOR COMPANY of Dearborn, Mich.

The VCS 104 may further include various types of computing apparatus in support of performance of the functions of the VCS 104 described herein. In an example, the VCS 104 may include one or more processors configured to execute computer instructions, and a storage medium on which the computer-executable instructions and/or data may be maintained. A computer-readable storage medium (also referred to as a processor-readable medium or storage) includes any non-transitory (e.g., tangible) medium that participates in providing data (e.g., instructions) that may be read by a computer (e.g., by the processor(s)). In general, a processor receives instructions and/or data, e.g., from the storage, etc., to a memory and executes the instructions using the data, thereby performing one or more processes, including one or more of the processes described herein. Computer-executable instructions may be compiled or interpreted from computer programs created using a variety of programming languages and/or technologies, including, without limitation, and either alone or in combination, Java, C, C++, C#, Fortran, Pascal, Visual Basic, Python, Java Script, Perl, PL/SQL, etc.

The VCS 104 may be configured to communicate with mobile devices 106 of the vehicle occupants. The mobile devices 106 may be any of various types of portable computing device, such as cellular phones, tablet computers, smart watches, laptop computers, portable music players, or other devices capable of communication with the VCS 104. As with the VCS 104, the mobile device 106 may include one or more processors configured to execute computer instructions, and a storage medium on which the computer-executable instructions and/or data may be maintained. In many examples, the VCS 104 may include a wireless transceiver (e.g., a BLUETOOTH controller, a ZIGBEE transceiver, a Wi-Fi transceiver, etc.) configured to communicate with a compatible wireless transceiver of the mobile device 106. Additionally, or alternately, the VCS 104 may communicate with the mobile device 106 over a wired connection, such as via a USB connection between the mobile device 106 and a USB subsystem of the VCS 104.

The wide-area network 108 may include one or more interconnected communication networks such as the Internet, a cable television distribution network, a satellite link network, a local area network, a wide area network, and a telephone network, as some non-limiting examples. Using an embedded modem of the VCS 104 (or a mobile device 106 of the user connected to the VCS 104), the vehicle 102 may be able to send outgoing data from the vehicle 102 to network destinations on the wide-area network 108, and receive incoming data to the vehicle 102 from network destinations on the wide-area network 108. An embedded modem of the VCS 104, or in other examples a local area connection of the VCS 104 to the mobile device 106, may include a cellular modem or other network transceiver configured to facilitate communication over the wide-area network 108 between the vehicle 102 and other devices of the system 100.

The vehicle 102 may be used for ride-sharing, and the ride-sharing server 110 may be configured to coordinate ridesharing for multiple users. To do so, the ride-sharing server 110 may manage pickup locations, drop-off locations, locations of vehicles 102, and request for ride-sharing from users of the system 100. In some examples, the ride-sharing server 110 may be designed to maximize the number of occupants within vehicles 102 to maximize revenue. This may include, for example, allowing a vehicle 102 with one rider to stop to pick up a second rider.

As a result, various passengers may be present in the vehicle seats of the ride-sharing vehicle 102 at different times during the rideshare. These additional occupants may change during a drive cycle of the vehicle 102, as compared to the relatively constant occupants of an owner-operated vehicle 102. Moreover, passengers of autonomous ride-sharing vehicles 102, such as autonomous taxis, may ride in more varied seating positions than occupants of manually-driven vehicles 102. One reason for this is that autonomous taxi vehicles 102 are rented to the user for a ride, as compared to drivers who consistently sit in a single seating location in the vehicle 102.

The vehicle 102 may include various configurable settings. For instance, the vehicle 102 may include individual seat control systems 112 to allow individuals to configure each seating position as desired. In an example, the individual seat control system 112 may allow the occupant to adjust physical settings of the seat itself, such as seat height, fore/aft position, or seat back recline angle. Additionally, the seating configurations for the seats may have rotatable or other flexible seating positions, in order to support interaction between different passengers when a group is traveling together, as well as to create separated spaces for occupants who are traveling alone. Thus, in some examples, the seat control system 112 may support settings with regard to seat rotation.

In another example, the individual seat control systems 112 of the ride-sharing vehicle 102 may include separate HVAC controls, similar to the individual front seat controls, for adjusting the HVAC system at each corresponding seating location. The vehicle 102 may also contain an HVAC system which has controls, blowers and vents for each seating position in the vehicle. In an example, vents for the HVAC system may be located in the roof of the vehicle 102 cabin to allow a flow of air to each passenger location regardless of seat position. The individual controls for the seat position and HVAC may be located at an ergonomically convenient location such as nearby side door panel or at the seat in front of the occupant. This may allow each of the seating locations to control the temperature of the air surrounding their seating location individually. If the seats are capable of rotation, the control location attached to the seat may provide improved accessibility when rotated, as opposed to the control locations on the side trim and seat back.

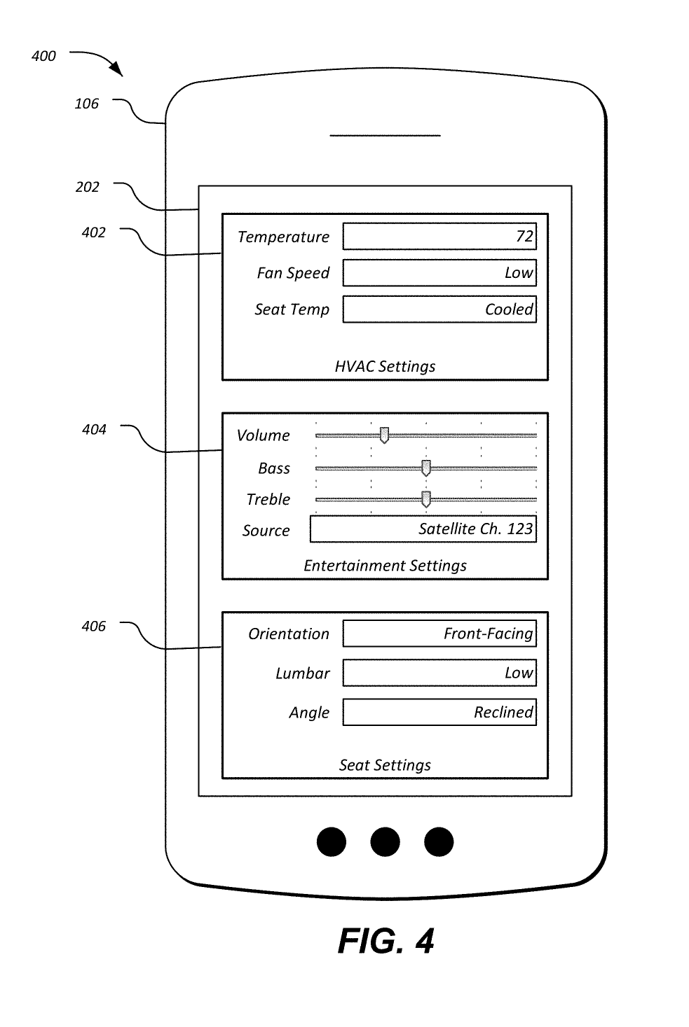

The personalized ride-sharing settings 114 may include the specific seat position, HVAC, seat rotation, or other settings for the occupant. Examples of the personalized ride-sharing settings 114 are discussed in detail below, for example with respect to FIG. 4.

The ride-sharing application 116 may be one application included on the storage of the mobile device 106. The ride-sharing application 116 may include instructions that, when executed by the processor of the mobile device 106, cause the mobile device 106 to send a request to the ride-sharing server 110 to request a vehicle 102 to provide the user of the mobile device 106 with a ride to a destination.

The ride-sharing application 116 may further include instructions allowing the user to specify personalized ride-sharing settings 114. For instance, the ride-sharing application 116 may provide a user interface via the mobile device 106 from which the user may specify the personalized ride-sharing settings 114 to be used in a request to the ride-sharing server 110 for a rideshare. In another example, the ride-sharing application 116 may maintain the personalized ride-sharing settings 114 to a storage of the mobile device 106, and may provide the maintained ride-sharing settings 114 with a request to the ride-sharing server 110 for a rideshare. In yet a further example, the ride-sharing application 116 may provide a user interface through which the user may specify the ride-sharing settings 114, and may upload the ride-sharing settings 114 to the server 110 for use in future rideshares.

By using the ride-sharing application 116, the ride-sharing settings 114 may be automatically applied to a seating location of the vehicle 102 selected by the occupant on the ride-sharing application 116. In an example, the ride-sharing application 116 may transfer the user's ride-sharing settings 114 to the vehicle 102, which then implements the seat, entertainment, and/or HVAC settings at the specified seating location. This could be done upon entry to the vehicle 102, or before entry, if the user reserves a specific seat when making an online reservation for the vehicle 102. Moreover, after the user has entered the vehicle 102, the user can continue to the ride-sharing application 116 to control the ride-sharing settings 114 for the current vehicle 102. Thus, the user may be able to use the same user interface for adjusting vehicle 102 settings once in the vehicle 102 as used to setting ride-sharing settings 114 before entering the vehicle 102.

In another more automated example, sensors 118 in the vehicle 102 may be used to locate the location of the mobile device 106 of the occupant within the vehicle 102, to automatically identify the seating position of the mobile device 106. In an example, the sensors 118 may provide signal strength information (e.g., received signal strength indication (RSSI) data) to the VCS 104 to allow the VCS 104 to triangulate or otherwise identify the seating location of the mobile device 106 within the vehicle 102. Responsive to the seating location of the mobile device 106 being identified, the mobile device 106 may be used to control the individual seat control systems 112 in that location via the saved ride-sharing settings 114 and/or via a user interface of the ride-sharing application 116. In another possibility, the ride-sharing application 116 may function in a fully-automatic mode using ride-sharing settings 114 stored to the mobile device 106 to update the individual seat control systems 112 for the seat location in which the mobile device 106 is located. This may be useful, as occupants in a shared vehicle 102 are unlikely to place their mobile device 106 in a different seating location open to be used by a different ride-sharing occupant.

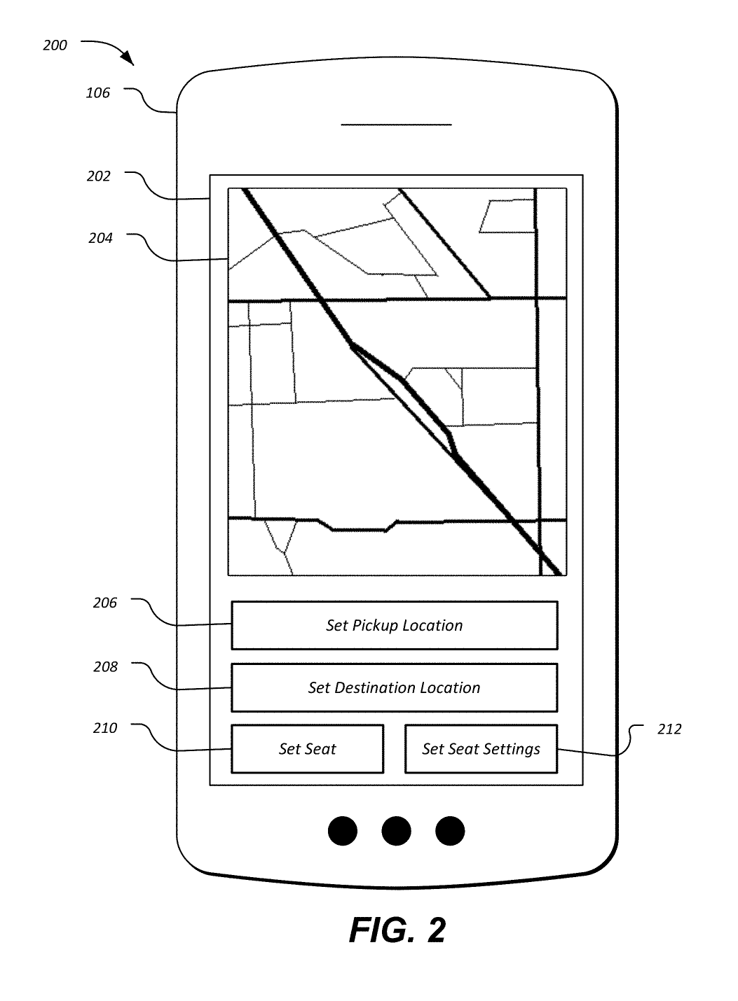

FIG. 2 illustrates an example user interface 200 of the mobile device 106 for selecting personalized ride-sharing settings 114 for an upcoming ride-share. As illustrated, the user interface 200 may be presented by the ride-sharing application 116 via a display 202 of the mobile device 106.

The user interface 200 may be used to collect information from a user of the mobile device 106 regarding an upcoming ride-share. In an example, the user interface 200 may include a map 204 displaying an area surrounding a current location of the mobile device 106. The map 204 may be adjustable by the user, e.g., via panning, scrolling, zooming in and out, etc., to allow the user to find locations for selection.

A set pickup location control 206 may be used to select a location at which the user is to be picked up for a ride-share. In an example, the user selects the set pickup location control 206 and then chooses a location from the map 204 as the pickup location. In another example, the user types an address into the set pickup location control 206 to be used as the pickup location.

A set destination location control 208 may be used to select a location at which the user is to be dropped off from the ride-share. In an example, the user selects the set destination location control 208 and then chooses a location from the map 204 to be the drop-off location. In another example, the user types an address into the set destination location control 208 to be used as the drop-off location.

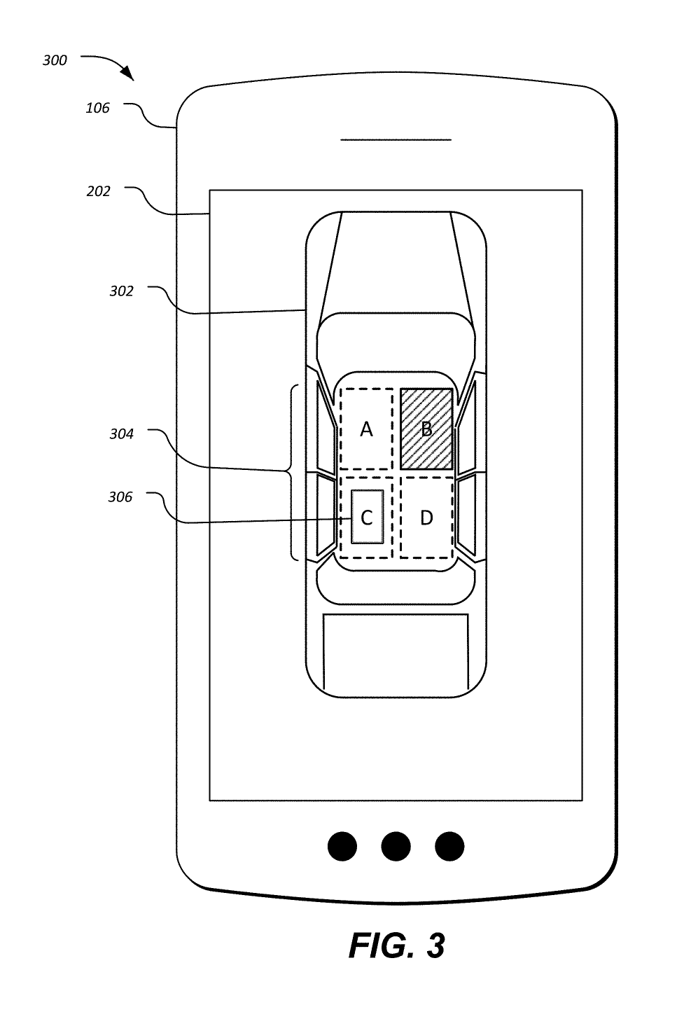

A set seat control 210 may be used to allow the user to configure which seating location of the vehicle 102 will be used for the user during the ride-share. In some examples, the set seat control 210 may be enabled only once a vehicle 102 has been chosen for the ride-share, as until that point it may not be known what seats are selectable. In other examples, the seat control 210 may be enabled to allow the user to enter a desired seat to be used to provide for matching of the user to vehicles 102 having that preferred seat open. Further aspects of setting the seat location are discussed with respect to FIG. 3.

A set seat settings control 212 may be used to allow the user to configure the personalized ride-sharing settings 114 to be applied to the vehicle 102. These personalized ride-sharing settings 114 may be applied to the vehicle 102, in an example, when the ride-share is successfully hailed. Further aspects of setting the seat settings are discussed with respect to FIG. 4.

FIG. 3 illustrates an example user interface 300 of the mobile device 106 for selecting a seat location for the ride-share. In an example, the user interface 300 may be displayed to the display 202 of the mobile device 106 by the ride-sharing application 116, responsive to selection of the set seat control 210 of the user interface 200.

As shown, the user interface 300 includes a vehicle graphic 302 representative of a vehicle 102 to perform the ride-share. In some examples, the vehicle graphic 302 may be representative of the model and/or color of the vehicle to perform the ride-share. In other examples, the vehicle graphic 302 may be of a generic vehicle 102, or of a generic vehicle 102 with the same number of seats or seat layout as the vehicle 102 to be used for the ride-share.

The user interface 300 may further include seat location indicators 304 indicative of the seating locations in the vehicle 102. As shown, the example vehicle 102 includes four seating location, e.g., A, B, C, and D. In other examples, different numbers or arrangements of seating locations may be shown. For instance, some vehicles 102 may have one, three or more than three rows of seats as opposed to two. Or, in some vehicles 102 there may be different numbers of seats available in different rows, such as two seats in a first row, three seats in a second row, and two seats in a third row.

The seating location indicators 304 may further show which seat locations are available for selection by the user. In an example, a seat that is unavailable for selection may be indicated in a different pattern or color than available seat locations. As shown, the seat location B is indicated as being unavailable. In some cases, seats may be shown as unavailable because they are already scheduled to be used by other ride-share users. In other cases, some seats may be unavailable at a certain price point, and may become available for an additional charge. In yet further cases, some seats may be unavailable because they lack certain features deemed necessary by the user in the user's personalized ride-sharing settings 114. For instance, a user may require a heated seat, so seats lacking that function may be marked as unavailable.

The user may utilize the user interface 300 to select a seat and/or to view the current seat selection. In one example, the user may touch the seat location on the screen to select that seat. As shown, the seat location C is currently selected, as noted by selection marker 306. Unavailable seats, such as the seat location B shown in the FIG. 3, may accordingly be unavailable for selection.

FIG. 4 illustrates an example user interface 400 of the mobile device 106 for configuring the personalized ride-sharing settings 114. In an example, the user interface 400 may be displayed to the display 202 of the mobile device 106 by the ride-sharing application 116 responsive to selection of the set seat settings control 212 of the user interface 200.

As shown, the user interface 400 includes HVAC settings 402, entertainment settings 404, and seat settings 406. The HVAC settings 402 may include, as some examples, personalized ride-sharing settings 114 for temperature, fan speed, and seat temperature (e.g., heated, cooled., etc.). The entertainment settings 404 may include, as some examples, personalized ride-sharing settings 114 for volume, bass, treble, audio source (e.g., satellite radio, terrestrial radio, station selection, genre selection, etc.). The seat settings may include, as some examples, personalized ride-sharing settings 114 for seat orientation (e.g., front-facing, rotates rear facing, privacy mode rotates to a window, etc.), lumbar settings, and seat angle or recline settings.

The personalized ride-sharing settings 114 as configured may be maintained in a storage of the mobile device 106. In other examples, the mobile device 106 may have an account with the ride-sharing server 110, and may additionally or alternately store the personalized ride-sharing settings 114 to the account on the ride-sharing server 110.

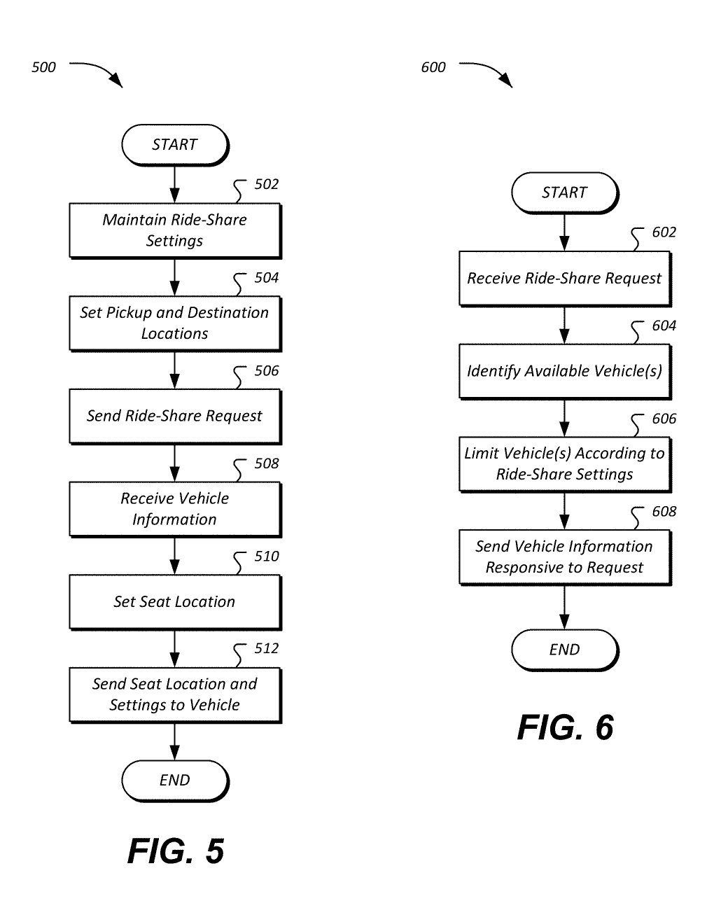

FIG. 5 illustrates an example process 500 of the vehicle 102 for a mobile device 106 requesting a ride-share using personalized ride-sharing settings 114. In an example, the process 500 may be performed by the mobile device 106 of the system 100.

At operation 502, the mobile device 106 maintains the personalized ride-sharing settings 114. In an example, the personalized ride-sharing settings 114 may be stored by the ride-sharing application 116 to a storage or other memory of the mobile device 106. In another example, the mobile device 106 may have an account with the ride-sharing server 110, and the ride-sharing application 116 may additionally or alternately upload or otherwise store the personalized ride-sharing settings 114 to the account on the ride-sharing server 110. The personalized ride-sharing settings 114 may be set by the user, e.g., using a user interface such as the user interface 400 discussed in detail above.

At 504, the mobile device 106 sets pickup and destination locations for the ride-share. In an example, the ride-sharing application 116 may display a user interface such as the user interface 200 discussed above. Using the user interface, the ride-sharing application 116 may receive the pickup and destination locations from a user of the mobile device 106. In some examples, the pickup location may be set to the current location of the user. In other examples, the user may select or enter both pickup and destination locations.

The mobile device 106 sends a ride-share request to the ride-share server 110 at 506. In an example, the ride-sharing application 116 may send the entered pickup and destination locations in a request to the ride-share server 110. In some cases, the ride-sharing application 116 may send additional information, such as a request for a type or quality of vehicle and/or the personalized ride-sharing settings 114 to be matched to an available vehicle 102 by the ride-share server 110.

At 508, the mobile device 106 receives information for the vehicle 102 selected to perform the ride-share. The received information may include, for example, timing information with respect to when the ride-share vehicle 102 is to arrive at the pickup location, information regarding the seating locations of the vehicle 102 such as availability and capabilities, a network address and/or phone number of the vehicle 102 to facilitate communicating between the VCS 104 of the vehicle and the mobile device 106, a seating location of the vehicle 102 selected for the rider to sit (which may be configurable), a make and model of the vehicle 102, a color of the vehicle 102, and so on.

At 510, the mobile device 106 sets the seat location within the vehicle 102 for the ride-share. In an example, the ride-sharing application 116 may provide a user interface for configuration of the seating location within the vehicle 102, such as the user interface 300. In another example, the ride-sharing application 116 may automatically utilize a selected location provided by the ride-share server 110. In yet a further example, the ride-sharing application 116 may utilize the personalized ride-sharing settings 114 to match with the information provided regarding the seating locations to automatically choose a seating location for the user. For instance, the personalized ride-sharing settings 114 may indicate that the user may prefer the back seat, so the ride-sharing application 116 may match the user with a seating location in the rear of the vehicle 102.

At operation 512, the mobile device 106 sends the seat location and personalized ride-sharing settings 114 to the vehicle 102. In an example, the ride-sharing application 116 may send the seat location and the personalized ride-sharing settings 114 to the address of the vehicle 102. In another example, the ride-sharing application 116 may send the information to the ride-sharing server 110, which in turn may provide it to the vehicle 102. In yet a further example, the ride-sharing application 116 may send the seat location to the ride-sharing server 110, and the ride-sharing server 110 may send the seat location and personalized ride-sharing settings 114 maintained by the ride-sharing server 110 to the vehicle 102. Using the personalized ride-sharing settings 114, the vehicle 102 may precondition the HVAC system, and set seat and entertainment settings in conformance with the user's settings for the seat location before the user enters the vehicle 102. After operation 512, the process 500 ends.

FIG. 6 illustrates an example process 600 for a ride-share server 110 managing a requested ride-share using personalized ride-sharing settings 114. In an example, the process 600 may be performed by the ride-share server 110 of the system 100.

At operation 602, the ride-share server 110 receives a ride-share request. In an example, the ride-share server 110 may receive the request from the mobile device 106 discussed above with respect to operation 506 of the process 500.

At operation 604, the ride-share server 110 identifies available vehicles 102. In an example, the ride-share server 110 may utilize pickup and destination locations to locate one or more vehicles 102 in geographic vicinity of the ride-share. The ride-share server 110 may additionally filter the identified vehicles 102 according to other information, such as type of vehicle 102 that is requested, quality of vehicle 102 that is requested, and whether the vehicle 102 has capacity or accepts to perform the ride-share.

At operation 606, the ride-share server 110 limits the available vehicles 102 according to the personalized ride-sharing settings 114. In an example, the ride-share server 110 may utilize personalized ride-sharing settings 114 received in the request to filter out vehicles 102 that lack one or more requirements for the user as specified by the personalized ride-sharing settings 114. In other examples, the ride-share server 110 may utilize personalized ride-sharing settings 114 for the user stored by the ride-share server 110, e.g., in association with an account identifier of the user provided in the request. As some non-limiting examples, the requirements may include, for example, a seat that supports reclining or rotation, that the HVAC system supports high heat, and so on.

At operation 608, the ride-share server 110 sends information regarding the vehicle 102. In an example, the ride-share server 110 provides the vehicle 102 information to the mobile device 106 responsive to the request from the mobile device 106. In some cases, the information may include a suggested seat location for the user, e.g., based upon the ride-sharing server 110 matching the user's personalized ride-sharing settings 114 to the capabilities of the vehicle 102. In some examples, the ride-share server 110 may send the user's personalized ride-sharing settings 114 and seat location information to the vehicle 102, while in other examples, this information is provided to the vehicle 102 from the mobile device 106, e.g., as discussed above with respect to operation 512 of the process 500. After operation 608, the process 600 ends.

In general, computing systems and/or devices such as VCS 104, mobile device 106, and ride-share server 110 may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS or QNX operating systems distributed by Research In Motion of Waterloo, Canada, and the Android operating system developed by the Open Handset Alliance.

Computing devices, such as the VCS 104, mobile device 106, and ride-share server 110, generally include computer-executable instructions that may be executable by one or more processors of the computing devices. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor or microprocessor receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computing device). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories, or other data stores, may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein. Some or all of the operations disclosed herein as being performed by the VCS 104, mobile device 106, and ride-sharing server 110, may be such computer program products. In some examples, these computer program products may be provided as software that when executed by one or more processors provides the operations described herein. Alternatively, the computer program products may be provided as hardware or firmware, or combinations of software, hardware, and/or firmware.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a mobile device associated with a user of a ride-share server, programmed to:
receive information indicative of a vehicle selected by the server to perform a ride-share,
identify a seating location within the vehicle, and
send the seating location and personalized ride-sharing settings for the user to the vehicle to cause the vehicle to precondition the seating location according to the settings, prior to the user entering the vehicle.

2. The system of claim 1, wherein the information indicates seating locations within the vehicle that are available for selection for the user to ride in via the mobile device.

3. The system of claim 2, wherein the information includes seating locations within the vehicle that are unavailable for selection for the user to ride in via the mobile device.

4. The system of claim 1, wherein the information includes a suggested seat location identified by the server according to the personalized ride-sharing settings.

5. The system of claim 1, wherein the mobile device is further programmed to provide a user interface for configuration of the personalized ride-sharing settings.

6. The system of claim 1, wherein the mobile device is further programmed to maintain the personalized ride-sharing settings at the ride-share server.

7. A method comprising:
receiving a ride-share request from a mobile device of a user;
identify a vehicle to perform the ride-share request by limiting available vehicles according to personalized ride-sharing settings of the user;
sending the vehicle an indication of the ride-share request and a seating location for the user; and
providing the vehicle with the personalized ride-sharing settings for preconditioning the seating location prior to the user entering the vehicle.

8. The method of claim 7, further comprising suggesting a seat location according to the personalized ride-sharing settings.

9. The method of claim 8, further comprising receiving input from the user overriding the seat location with another seat location.

10. The method of claim 9, further comprising applying the personalized ride-sharing settings to individual seat control systems corresponding to the seating location to perform the preconditioning.

11. The method of claim 7, wherein the ride-share request includes a pick-up location and a destination location.

12. The method of claim 7, wherein the preconditioning includes setting a temperature setting of the seating location, setting a blower speed of the seating location.

13. The method of claim 7, wherein the preconditioning includes setting an audio source and volume of the seating location.

14. The method of claim 7, wherein the preconditioning includes setting a seat orientation of the seating location.

15. A non-transitory computer-readable medium including instructions that, when executed by a processor of a computing system of a vehicle, cause the system to:
receive personalized ride-sharing settings for preconditioning a seating location of the vehicle, responsive to selection of the vehicle for performing a ride-share for a user; and
apply the settings to control systems to adjust seating, entertainment, and ventilation settings of the seating location prior to the user entering the vehicle.

16. The medium of claim 15, wherein the personalized ride-sharing settings are received from a ride-sharing server to a network address of the computing system of the vehicle.

17. The medium of claim 15, wherein the personalized ride-sharing settings are received from a mobile device of the user to a network address of the computing system of the vehicle.
